(19) United States
(12) Patent Application Publication
(10) Pub. No.: US 2023/0135703 A1
(43) Pub. Date: May 4, 2023

(54) IMPLEMENTING MACHINE LEARNING IN A LOW LATENCY ENVIRONMENT

(71) Applicant: Etsy, Inc., Brooklyn, NY (US)

(72) Inventor: Zoë Frances Weil, Brooklyn, NY (US)

(21) Appl. No.: 17/517,843

(22) Filed: Nov. 3, 2021

(51) Int. Cl. G06Q 30/06; G06Q 30/02; H04L 29/08

(52) U.S. Cl. CPC G06Q 30/0631; G06Q 30/0202; G06Q 30/0643; H04L 67/22

(57) ABSTRACT

Approaches are described for implementing machine learning in a low latency environment. In one aspect, a method includes: obtaining session records from each of one or more users; identifying, across the session records, a set of behavior records indicative of at least a specified number of most frequent behaviors; generating an embedding for each behavior record in the set of behavior records; storing the generated embeddings for the set of behavior records in a first database; obtaining a current behavior record from the user; matching the current behavior record to a matching set of stored behavior records; selecting the stored embedding of the matching set of stored behavior records as an embedding of the current behavior record based on the matching and within a real-time constraint following entry of the current behavior record by the user; and generating a predicted next action of the user.

### BACKGROUND

The present disclosure relates to computer-implemented methods, systems, and apparatuses, for enabling the use of machine learning models in a low latency environment and/or using fewer computing resources than required by traditional machine learning systems.

Machine learning systems are trained and invoked to predict occurrences of event. For example, machine learning systems can be trained using historical data and labelled outcomes to predict future outcomes based on newly acquired data. These systems can be useful in a variety of use cases, but the ability to utilize machine learning can be limited based on the computing resources available and/or time constraints in which a computer system must generate a result.

### SUMMARY

In general, one innovative aspect of the subject matter described in this specification can be embodied in methods including obtaining, by one or more computers, session records from each of one or more users, wherein the session records specify information indicative of behaviors by the one or more users over a period of time; identifying, by the one or more computers and across the session records, a set of behavior records indicative of at least a specified number of most frequent behaviors; generating, by the one or more computers and for each behavior record in the set of behavior records, an embedding; storing, by the one or more computers, the generated embeddings for the set of behavior records in a first database; obtaining, by the one or more computers and from the user, a current behavior record; matching, by the one or more computers, the current behavior record to a matching set of stored behavior records; selecting, by the one or more computers, the stored embedding of the matching set of stored behavior records as an embedding of the current behavior record based on the matching and within a real-time constraint following entry of the current behavior record by the user; and generating, by the one or more computers and based on the embedding of the matching set of stored behavior records, a predicted next action of the user after entry of a last token in the current behavior record by the user.

Embodiments can include one or any combination of two or more of the following features.

The method includes generating candidate behavior records, each indicative of the predicted next action following the last token in the current behavior record by the user; identifying, across the candidate behavior records, a set of candidate behavior records indicative of at least a specified number of most frequent candidate behaviors; generating, for each candidate behavior record in the set of candidate behavior records, an embedding; storing the generated embeddings for the set of candidate behavior records in a second database; obtaining, from the user, a current candidate behavior record; matching the current behavior record to a matching set of stored candidate behavior records; and selecting the stored embedding of the matching set of stored candidate behavior records as an embedding of the current candidate behavior record based on the matching and within a real-time constraint following generating the candidate behavior record. The method includes generating a ranker model that predicts a likelihood of each candidate behavior record leading to one or more actions by the user; obtaining the score, for each candidate behavior record, based on the ranker model and the embedding of the candidate behavior record; and providing, for output on a user interface, the candidate behavior record that exceeds a predefined threshold as a predicted next action, wherein the predicted next action is identified and outputted within a real-time constraint after entry of the last token in the current behavior record by the user.

Other embodiments of this aspect include corresponding systems, devices, apparatus, and computer programs configured to perform the actions of the methods. The computer programs (e.g., instructions) can be encoded on computer storage devices.

These and other embodiments can each optionally include one or more of the following features. Sessions records include an identifier of the user and one or more behaviors by the user, wherein behaviors comprise one or more tokens received from the user and one or more actions taken by the user within the period of time. Tokens include one or more query terms entered by the user. Generating an embedding includes creating a vector representation in a low dimensional space. Matching the current behavior record to a matching set of stored behavior records includes determining a measure of similarity between the current behavior record and each behavior record in the first database and identifying the matching set of behavior records based on the measure of similarity.

Particular embodiments of the subject matter described in this specification can be implemented so as to realize one or more of the following advantages. For example, the techniques discussed in this specification can be implemented to enable the use of machine learning in situations where traditional machine learning approaches may not be feasible. More specifically, the techniques discussed herein enable machine learning to be utilized in systems that do not have the processing resources required to implement traditional machine learning techniques. Also, the techniques discussed herein enable machine learning to be utilized in time constrained systems that require an output from the machine learning system more quickly than feasible by traditional machine learning techniques. For example, the techniques discussed herein enable complex machine learning to be implemented in real-time systems, some of which are required to provide answers in less than 15 milliseconds, whereas traditional machine learning techniques could take at least one second or longer.

As discussed throughout this document, the techniques that enable machine learning to be implemented in these low-latency and/or low computing resource environments include breaking the overall machine learning techniques into sub-parts and implementing each part in a way that still considers a long activity history, while also utilizing the most recent data. For example, one technique can be used to reduce the amount of processing required to identify and/or use the long activity history, while another technique can be used to ensure that the most recent data is obtained and used in the training and prediction.

An example system in which these techniques may be used is a real-time search suggest system that requires a historically-context-aware approach to making suggestions (e.g., based on historical query/action data) as well as a real-time-context-aware approach (e.g., the ability to use current user input, such as a last entered token to make an appropriate suggestion). However, any system that requires lower latency and/or lower computing resources can benefit from the techniques discussed herein.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example computing environment.

FIGS. 2A-B illustrate an example application.

FIGS. 3A-B illustrates an example component architecture.

FIG. 4 is a flowchart of an example process.

Like reference numbers and designations in the various drawings indicate like elements.

### DETAILED DESCRIPTION

The present disclosure relates to approaches to implementing machine learning in a low latency environment. Implementing machine learning includes steps of training a predictive model using training data and applying a pre-trained model to new data to make predictions. A system that implements machine learning (also referred to as a machine learning system) is configured to meet a certain latency constraint, e.g., computational resources and time. In some implementations, the low latency environment is a time constrained system, where time or computational resources needed for providing predictions must meet an acceptable threshold. For example, the machine learning system that implements a real-time prediction of next action of the user after entry of a last token (e.g., a search query) in a current behavior record requires latency in a scale of milliseconds (or tens of milliseconds). The current behavior record indicates the (near) real-time user’s behavior interacting with the system, and can be represented by one or more tokens. To enable machine learning in such low latency environment, the present disclosure describes an architecture that includes sub-parts of the machine learning techniques, where each part of the system can be pre-trained, ran in parallel, or in combinations with other parts. Specifically, storing pre-processed data based on at least a specified number of most frequent data (e.g., behavior records, continuing above example) in a database enables real-time processing, for example, in response to a most recently entered token by the user.

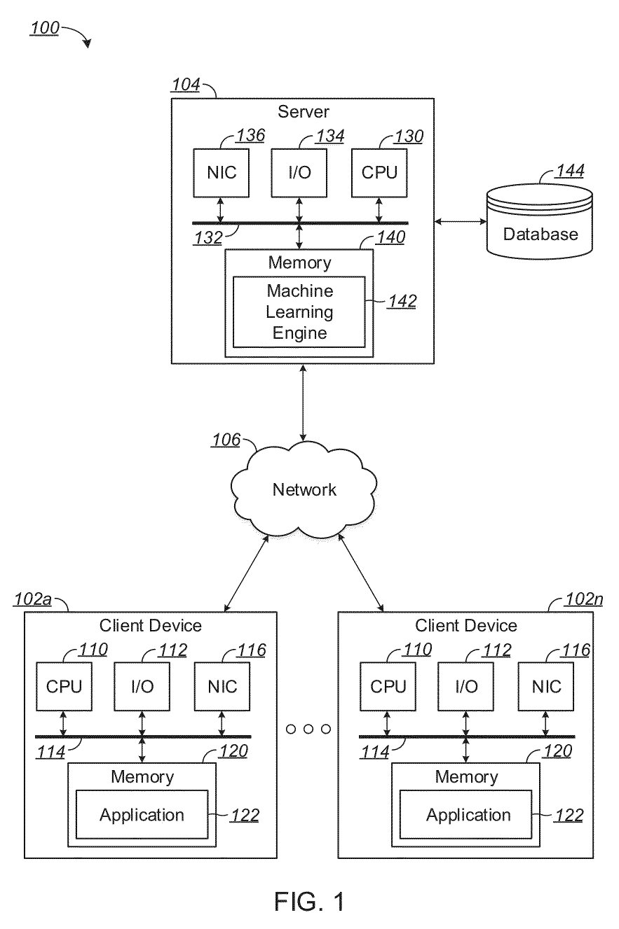

FIG. 1 illustrates an example computing environment 100. The system 100 includes a plurality of client devices 102a through 102n in communication with a server 104 via a network 106, which may be a wired or wireless network or any combination thereof. Each client device 102a through 102n (referred to collectively as client devices 102) includes a processor (e.g., central processing unit) 110 in communication with input/output devices 112 via a bus 114. The input/output devices 112 can include a touch display, keyboard, mouse, and the like.

A network interface circuit 116 is also connected to the bus 114 to provide wired and/or wireless connectivity to the network 106. A memory or other storage medium 120 is also connected to the bus 114. The memory 120 stores instructions executed by the processor 110. In particular, the memory 120 stores instructions for an application 122, such as an electronic commerce application, which communicates with the server 104. In some implementations, each client device 102 is a mobile device (e.g., smartphone, laptop, tablet, wearable device, digital assistant device, etc.) executing the application 122. Different client devices 102 are operated by different users that use the same application 122. The application 122 can include a mobile application and a web environment displayed by a browser program.

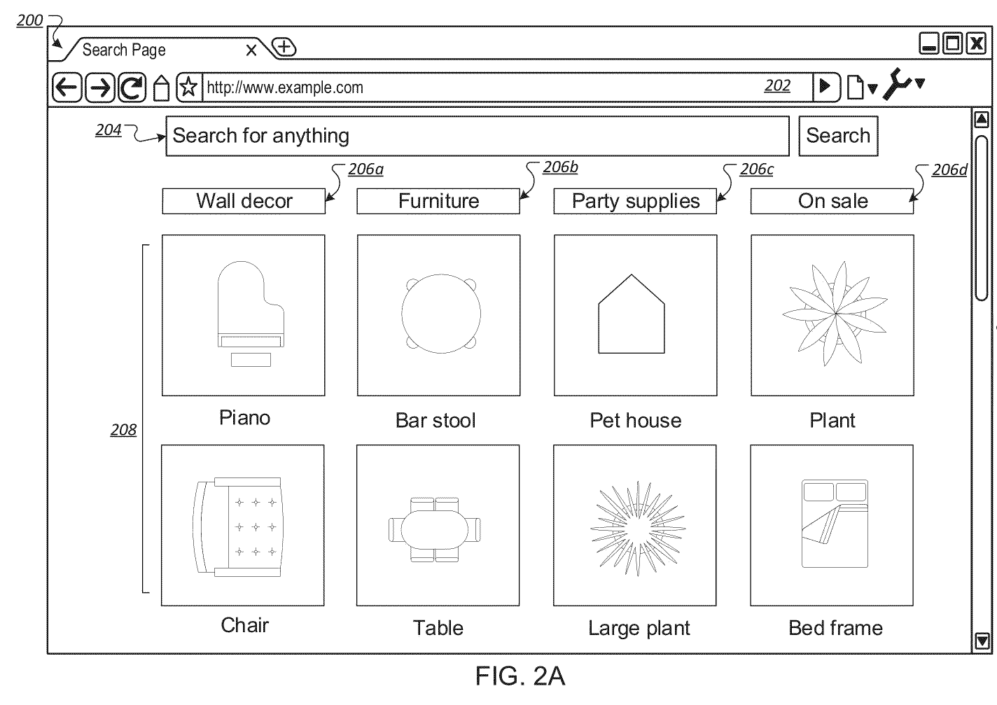

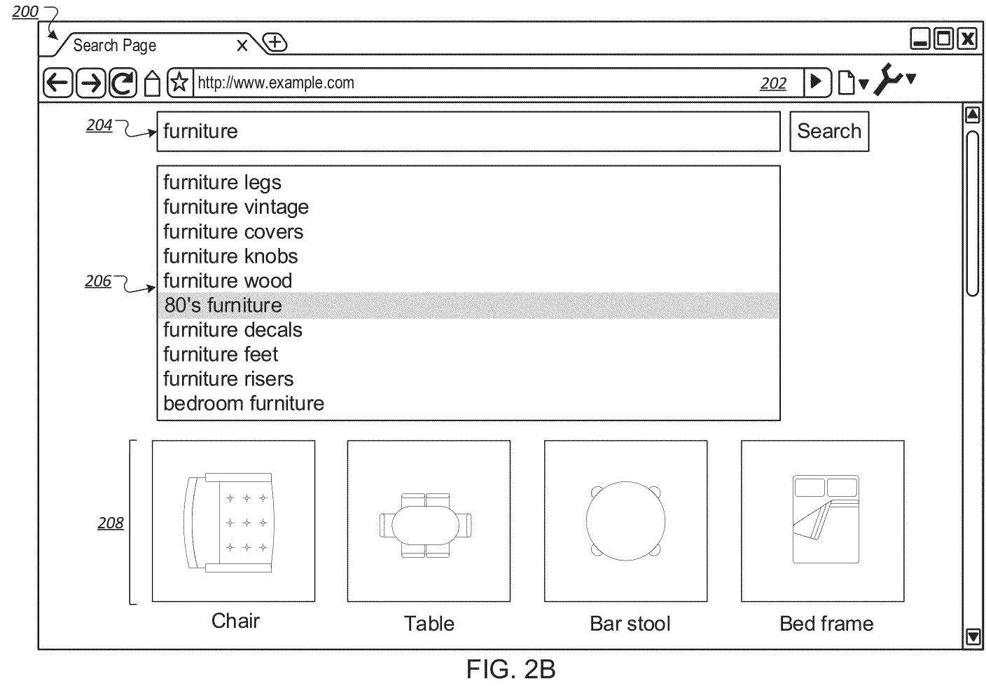

The server 104 includes a processor 130, bus 132, input/output devices 134 and a network interface circuit 136 to provide connectivity to the network 106. A memory 140 is connected to the bus 132. The memory 140 stores a machine learning engine 142 with instructions executed by the processor 130 to implement operations disclosed in connection with FIGS. 2 through 4. In some implementations, the system 100 includes a database 144 in communication the server 104 that stores information for use by the application 122 and/or the machine learning engine 142.

The machine learning engine 142 implements machine learning techniques, e.g., predicting next action of the user (described in more details below). The database 144 can include user information (e.g., identifier of the user, demographic information) and session records of the user (e.g., tokens received from the user, actions taken by the user; collectively defined as user behaviors). As a particular example, tokens include queries (e.g., search terms) by the user, and actions taken by the user include interaction, by the user, with a user selectable element (e.g., clicking on a link for an item, or purchasing an item). In some implementations, the system 100 processes information in the database 144 (e.g., by generating fast-access identifiers or references) such that the access to the information is computationally efficient. For example, the system 100 can apply the filter of a particular user to the database 144 to obtain records associated with the particular user. In some implementations, the system 100 optimizes a structure of the database 144 based on a data processing bandwidth to facilitate load balancing.

FIG. 2A illustrates an example application 200. The application 200 is an electronic commerce environment generated at least in part using data provided by a computer system and may be displayed by a browser program operating on the client device 102, such as a personal computer connected to the computer system over a network (e.g., the Internet). The application 200 is displayed by the browser program under an example web address 202. The example web address 202 contains at least an address that the user can type on the browser program to reach the application 200.

The application 200 includes a search query entry field 204. In some implementations, the search query entry field 204 may be initially empty, allowing the user to enter a new search query. In some implementations, the search query entry field 204 may include “search for anything” to indicate the user to enter a new search query. The user may be an account holder of a user account, or an authorized user of an account on the application 200. The user may select “Search” button next to the search query entry field 204 or may press the keyboard button to complete a new search query. The text that the user enters into the search query entry field 204 (example tokens received from the user) may subsequently be used by the computer system (e.g., a web server) to generate a set of search results based on the search query using one or more search algorithms.

The application 200 can include a set of recommended queries 206a-206d. In some implementations, the set of recommended queries 206a-206d can be based on the user’s session records (e.g., search history for over a period of time). For example, the application 200 may show “party supplies” 206c to the user, based on the user’s search history related to party supplies. In some implementations, the recommended queries 206a-206d can be based on data pertaining to other users’ sessions. For example, the application 200 may show “furniture” 206b as the environment 200 identified “furniture” as a popular search query based on the session records of other users past week.

In some implementations, the set of recommended queries 206a-206d are based on actions taken by the user within a specified period of time. Actions taken by the user include selecting a user selectable element, e.g., related to a set of merchandise items 208 (clicking a link to browse a merchandise, adding a merchandise to a shopping cart; setting a merchandise as a favorite, selecting an advertisement), and viewing a particular screen of the application 200.

The set of merchandise items 208 may also be customized to the user. In some implementations, the set of merchandise items related to a latest (e.g., most recently submitted) token (e.g., a search term) by the user can be presented. In some implementations, the featured merchandise items, based on recent popularity of merchandise items or other users’ session records, can be presented to the user.

As an example of implementing machine learning in a low latency environment, FIG. 2B illustrates a real-time search suggest system on the application 200. The real-time search suggest system outputs one or more search terms that are predicted to be of interest to the user after receiving a search query by the user. In the illustrated example, the search query that the user entered into the search query entry field 204 is “furniture.” In response to the search query, the machine learning system generates a set of recommended queries 206 within a real-time constraint, e.g., “furniture legs”, “furniture vintage,” and “bedroom furniture.”

When the user selects one of the suggested queries, the selected search term is highlighted. For example, the term “80’s furniture” is highlighted upon the user’s selection. Then, the application 200 displays updated search results based on the selected query of “80’s furniture.” In some implementations, the recommended queries 206 can be displayed as one or more selectable elements. The machine learning system that utilizes the user session in predicting next action of the user (e.g., generating search terms that are predicted to be of interest to the user, predicting an user selectable element the user will select, predicting a merchandise the user will purchase) is discussed in more details below.

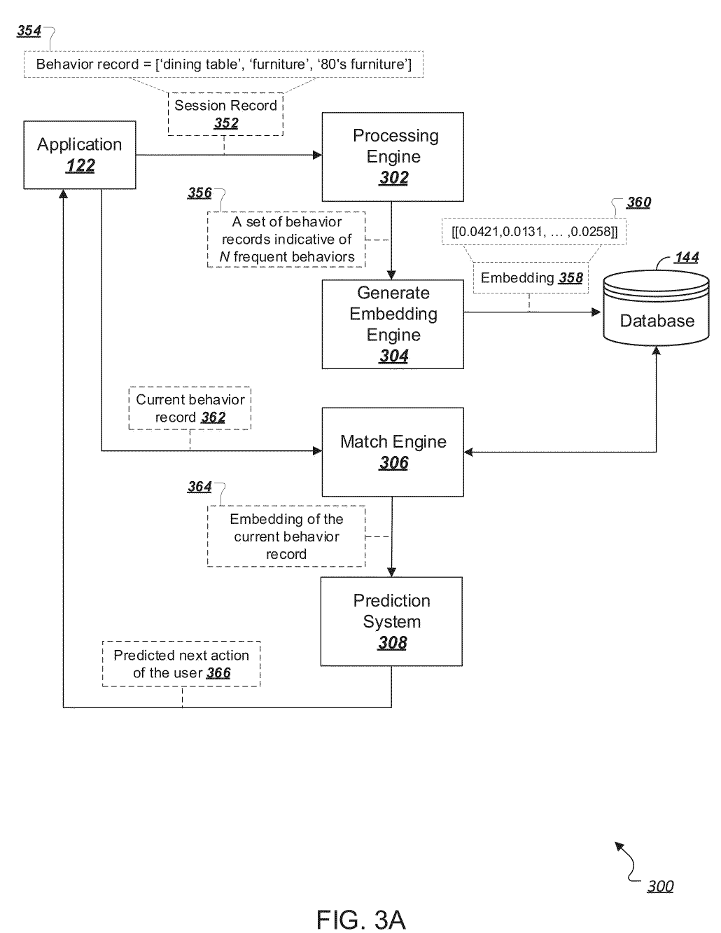

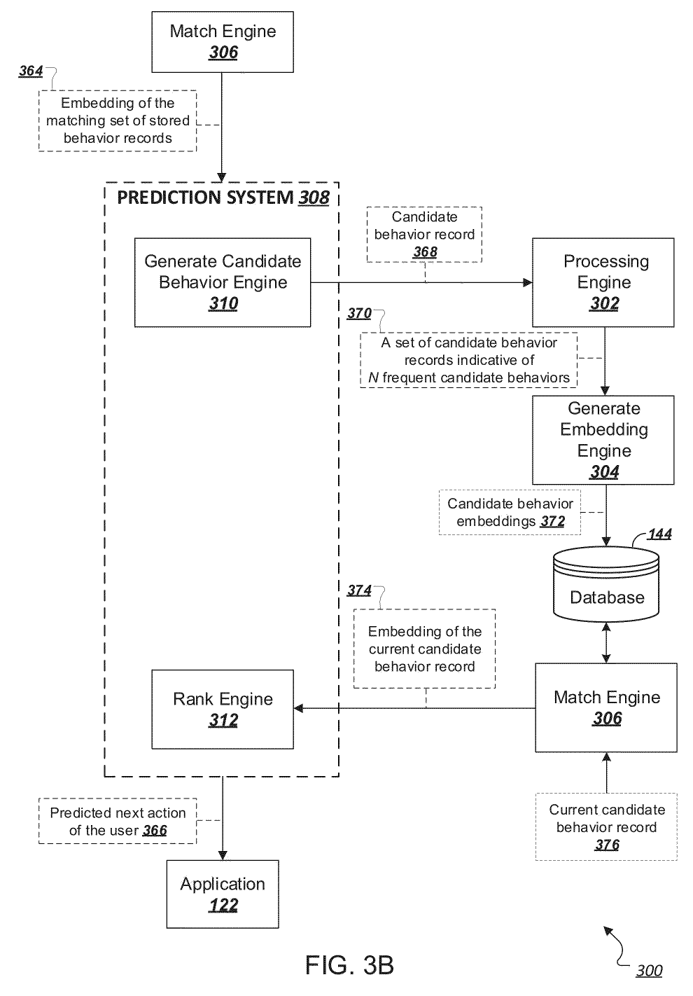

FIG. 3A illustrates an example component architecture 300 of the machine learning engine 142 that generates a predicted next action of the user after entry of a last token. With reference to FIG. 3, and throughout this document, the “engines” discussed can include a combination of hardware and software elements, such that each engine can include one or more processors or other computing devices.

The architecture 300 includes a processing engine 302 that obtains a session record 352 from each of one or more users of the application 122 (e.g., the electronic commerce environment as illustrated in FIGS. 2A-B). For example, the application 122 transmits the session record 352 via the network 106. In some implementations, as described above, the database 144 can contain the session record 352 so that the processing engine 302 can retrieve appropriate session records based on a given time period.

The session record 352 specifies information indicative of behaviors by the one or more users over a period of time. As a particular example, the session record 352 includes an identifier of the user and a behavior record 354 that includes one or more tokens received from the user (e.g., “dining table”, “furniture”, “80’s furniture”, where “dining table” is the most recent token) by the user from a period of time (e.g., 14 days or any other appropriate timeframe). In some implementations, the behavior record 354 includes one or more actions taken (e.g., clicking a merchandise, purchasing a merchandise, or setting a merchandise or a seller as a favorite) by the user within a period of time (e.g., behavior record = [“dining table”, clicking a user selectable element, “furniture”, adding a merchandise to a shopping cart, ...]). In some implementations, the session record 352 includes corresponding timestamps of each tokens and each actions, e.g., 2:14PM when the user clicked a merchandise.

After obtaining the session record 352, the processing engine 302 identifies a set of behavior records indicative of at least a specified number (N) of most frequent behaviors (also referred to as frequent behavior records 356). For example, the frequent behavior records 356 can include a search token “furniture” that appears frequently among users’ queries in past 14 days. In some implementations, the processing engine 302 sorts the obtained behavior records 354 based on the number of occurrence within a period of time and selects the N most frequent behavior records, where N is a pre-determined constant (e.g., 100 million).

A Generate Embedding Engine 304 receives the frequent behavior records 356 and generates an embedding 358 for each behavior record in the frequent behavior records 356. In some implementations, the Generate Embedding Engine 304 creates a vector representation in a low dimensional space for each behavior record, e.g., converting the alphanumeric text to a 512-bit vector 360 to represent each token (e.g., “furniture”). A length of the vector is based on a predetermined size by the architecture 300. Upon generating the embedding for each behavior record, the Generate Embedding Engine 304 stores the generated embeddings in a database, e.g., database 144.

The pre-computed embeddings stored in the database 144 can reduce computational time and usage of computational resources such that the system (e.g., the machine learning engine 142) can generate an embedding of a new behavior record within a real-time constraint. For example, when the session record 352 includes millions of tokens even after restricting to behavior records from past 7 days, the database 144 that contains the pre-computed embeddings can enable the system to meet the latency requirement. For example, the system can look up the embedding in the database based on the new behavior record and generate an embedding of the new behavior based on the look up results or inference.

The architecture 300 includes a Match Engine 306 that obtains a current behavior record 362 and matches the current behavior record 362 to a matching set of stored behavior records in the database 144. The current behavior record 362 can include a last token by the user (e.g., when a user inputs a new search query).

The Match Engine 306 determines a measure of similarity between the current behavior record 362 and each behavior record in the database 144. In some implementations, the measure of similarity is a pairwise correlation between a pair of behavior records. In some implementations, the measure of similarity is based on a distance (e.g., in a low dimensional space) from the current behavior record 362 to each behavior record in the database 144. Based on the measure of similarity, the Match Engine 306 identifies the matching set of behavior records. In some implementations, the matching set of behavior records is the nearest neighbor of the current behavior record 362 in a low dimensional space.

The Match Engine 306 selects the stored embedding of the matching set of stored behavior records as an embedding of the current behavior record 364 based on the matching and within a real-time constraint followed entry of the current behavior record 362 by the user. In some implementations, the Match Engine 306 infers the embedding of the current behavior record 364 based on the measure of similarity.

A prediction system 308 receives the embedding of the current behavior record 364 and generates a predicted next action of the user 366. Referring to FIG. 3B, the prediction system 308 includes a Generate Candidate Behavior Engine 310. The Generate Candidate Behavior Engine 310 generates candidate behavior records 368, each indicative of the predicted next action following the last token in the current behavior record 362 by the user. For example, the candidate behavior records 368 can include a set of queries likely to be of interest to the user (e.g., “furniture legs” for the case of the last token being “furniture”). The number of candidate behavior records is based on a pre-determined number.

In some implementations, the Generate Candidate Behavior Engine 310 generates the candidate behavior records 368, based on a co-occurrence-based algorithm. The co-occurrence-based algorithm uses a pre-trained model of how different behavior records interact, or co-occur in a given session record of the user, using the session record 352 as training data.

In some implementation, the Generate Candidate Behavior Engine 310 generates the candidate behavior records 368, based on a generative model. Training the generative model, analogous to a next sentence prediction task, involves predicting a next, or candidate, behavior in a user session. The generative model can be trained on the session record 352, where a most recent token is treated as a future token (held out as evaluation data), a second most recent token is treated as a current token, and rest of tokens are treated as past tokens. Using these training data, the generative model finds parameters such that it maximizes a given log probability. Based on evaluation metrics (e.g., BLEU and ROUGE scores), the generative model can be optimized (e.g., by varying one or more of training parameters) to achieve an acceptable level of performance.

The prediction system 308 transmits the candidate behavior records 368 to the processing engine 302 that identifies a set of candidate behavior records indicative of at least a specified number (N) of most frequent candidate behaviors (also referred to as frequent candidate behavior records 370). The Generate Embedding Engine 304 generates an embedding 372 for each candidate behavior record in the frequent candidate behavior records 370).

Upon generating the embedding for each candidate behavior record, the Generate Embedding Engine 304 stores the generated embeddings in a database, e.g., database 144. The database that stores the frequent candidate behavior records 370 may be same or different than the database that stores the frequent behavior records 356.

The Match Engine 306 obtains a current candidate behavior record 376 and matches the current candidate behavior record 376 to a matching set of stored candidate behavior records in the database 144. The current candidate behavior record 376 is real-time candidate behavior records generated after receiving a last token in the current behavior record 362 by the user.

The Match Engine 306 determines the measure of similarity between the current candidate behavior record 376 and each candidate behavior record in the database 144 (the measure of similarity was previously discussed above). The Match Engine 306 selects the stored embedding of the matching set of stored candidate behavior records as an embedding of the current candidate behavior record 374 based on the matching and within a real-time constraint followed entry of the current behavior record 362 by the user. In some implementations, the Match Engine 306 infers the embedding of the current candidate behavior record 374 based on the measure of similarity.

The architecture 300 includes a Rank Engine 312 that obtains the embedding of the current candidate behavior record 374 and outputs predicted next action of the user 366. The Rank Engine 312 generates a score for each candidate behavior record, where the score (e.g., ranging from 0 to 1) represents a likelihood of each candidate behavior record leading to one or more actions by the user.

In some implementations, the score is based on the predicted occurrence of one or more following actions following the last token in the current behavior record by the user: purchasing a merchandise, adding a merchandise to a shopping cart, setting a merchandise or a seller as favorite, selecting an advertisement, or similar behaviors.

In some implementations, the Rank Engine 312 generates the score for each candidate behavior record based on a context-aware ranker model. The context-aware ranker model takes account of multiple candidate behavior records (and their interactions amongst). The context-aware ranker model can be trained on the session record 352 or synthetic data, using series of encoder blocks, e.g., f(x) = FC(encoder(encoder(... (encoder(FC(x))))), where FC represents a fully connected layer, and x is an input. As an output of the context-aware ranker model, a list of scores, each score corresponding to each candidate behavior record, is returned to the Rank Engine 312.

After obtaining the score, the Rank Engine 312 provides the candidate behavior record that exceeds a predefined threshold as a predicted next action. The predicted next action is identified and outputted on a user interface of the application 122 within a real-time constraint after entry of the last token in the current behavior record by the user. For example, the recommended queries 206 from FIG. 2B can be the predicted next action.

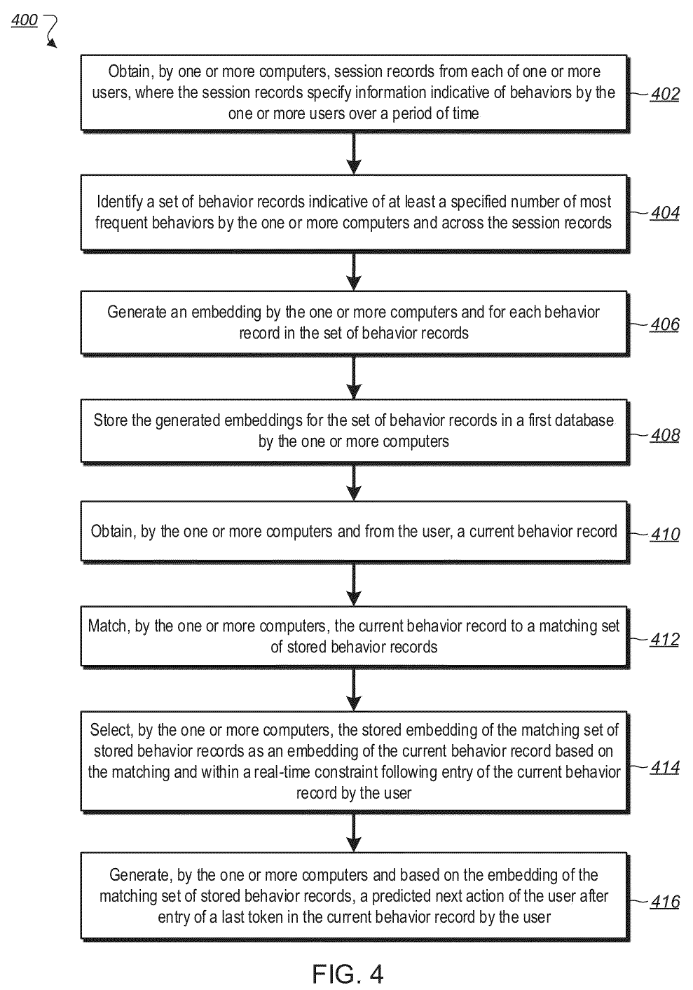

FIG. 4 is a flowchart of an example process 400 for implementing machine learning in a low latency or resource constrained environment. For purposes of example, the description of FIG. 4 refers specifically to a task of predicting next action of the user based on historical and current records associated with the user within a real-time constraint. The process will be described as being performed by a system of one or more computers programmed appropriately in accordance with this specification. For example, the machine learning engine 142 from the system 100 of FIG. 1 can perform at least a portion of the example process. In some implementations, various steps of a method of predicting next action of the user within a real-time constraint can be run in parallel, in combination, in loops, or in any order. Of course, operations similar to those described with reference to the process 400 can be used to implement other predictions using machine learning. Further, operations of the process 400 can be implemented as instructions stored on a computer readable medium, which can be non-transitory, and execution of the instructions can cause one or more data processing apparatus to perform operations of the process 400.

The system obtains session records from each of one or more users (402). The session records specify information indicative of behaviors by the one or more users over a period of time. The users can be the users of the application 122. In some implementations, the session records include an identifier of the user and one or more behaviors by the user. The behaviors include one or more tokens received from the user (e.g., queries by the user) and one or more actions taken (e.g., selecting a user selectable element by the user) by the user within the period of time (e.g., past 7 days). In some implementations, the system obtains the tokens and the actions taken by the user as separate data.

For example, each token can represent a search term input by the user, and each search term can be obtained prior to submission of the search query (e.g., prior to a user interacting with a “submit search” button, or pressing an “enter” key). In a specific example, the search query “rocking chair” can be represented by a token corresponding to the term “rocking” and another token corresponding to the term “chair”. In this example, the first token can be received once the user has typed the work “rocking” into a search box, and the other token can be received once the user has typed the work “chair” into the search box, and receipt of the tokens is not dependent on the user taking any affirmative action to submit the search query for processing.

The system identifies a set of behavior records indicative of at least a specified number of most frequent behaviors across the session records (404). In some implementations, the system counts the number of occurrence of each unique behaviors from the session records. In some implementations, the system sorts each unique behaviors based on the number of occurrence within a period of time and selects the specified number of most frequent behaviors across the session records. Continuing with the specific example above, the unique behaviors can be submissions of specific tokens or combinations of tokens, interactions with links presented to the user, and/or post search activities, such as completing a transaction or requesting additional information about an item.

In some implementations, the system imposes filtering on the session records such that the set of behavior records include particular behaviors. For example, the system can impose filtering on the session records to obtain only queries by the user (e.g., search terms received by the user).

The system generates an embedding for each behavior record in the set of behavior records (406). In some implementations, each behavior record is an alphanumerical text (e.g., “furniture”). In some implementations, for each behavior record, the system generates an embedding by creating a vector representation in a low dimensional space, e.g., 512-bit vector consisting of floating values.

The system stores the generated embeddings for the set of behavior records in a first database (408). The database 144 that communicates the server 104 can include the first database. In some implementations, the system stores the generated embeddings and their corresponding keys based on corresponding behavior records such that the system can look up, or inference, the embedding in the first database based on a given behavior record.

The system obtains a current behavior record from the user (410). The current behavior record includes the (near) real-time user’s behavior interacting with the system (e.g., the application 122). For example, the token just received by the user (e.g., one or more search terms of the search query “vintage furniture”) is an example token represented by the current behavior record.

The system matches the current behavior record to a matching set of stored behavior records (412). In some implementations, the system determines a measure of similarity between the current behavior record and each behavior record in the first database and identifies the matching set of behavior records based on the measure of similarity. For example, the matching set of behavior records can be a set of the stored behavior records that include the same tokens as the current behavior record, or a set of the stored behavior records that has at least a specified portion of the same tokens as the current behavior record. In some situations, the tokens need not be the same between the two sets of behavior records if they are semantically similar.

The system selects the stored embedding of the matching set of stored behavior records as an embedding of the current behavior record based on the matching and within a real-time constraint following entry of the current behavior record by the user (414). In some implementations, the system infers the embedding of the current candidate behavior record for the case that the exact matching was not found, e.g., based on the nearest neighbors algorithm by comparing the current behavior record to the stored behavior records in the first database. By using the stored embeddings, the system does not have to regenerate the stored embeddings, and therefore, can operate more quickly on the embeddings.

The system generates a predicted next action of the user based on the embedding of the matching set of stored behavior records after entry of a last token in the current behavior record by the user (416). In some implementations, generating the predicted next action of the user includes suggesting tokens (e.g., query terms) likely to be of interest to the user. In some implementations, generating the predicted next action of the user includes predicting the user’s activity interacting with the system (e.g., clicking a particular user selectable element; viewing a particular page).

In some implementations, the system generates candidate behavior records. Each candidate behavior record indicates the predicted next action following the last token in the current behavior record by the user. The system identifies, across the candidate behavior records, a set of candidate behavior records indicative of at least a specified number of most frequent candidate behaviors. The system generates, for each candidate behavior record in the set of candidate behavior records, an embedding. The system stores the generated embeddings for the set of candidate behavior records in a second database. In some implementations, the database 144 that communicates the server 104 can include the second database. The system obtains, from the user, a current candidate behavior record. The system matches the current behavior record to a matching set of stored candidate behavior records. The system selects the stored embedding of the matching set of stored candidate behavior records as an embedding of the current candidate behavior record based on the matching and within a real-time constraint following generating the candidate behavior record.

In some implementations, the system generates a ranker model that predicts a likelihood of each candidate behavior record leading to one or more actions by the user. The system obtains the score, for each candidate behavior record, based on the ranker model and the embedding of the candidate behavior record. In some implementations, the ranker model is a context-aware ranker model trained on the session records (either synthetic or historical data). The system provides, for output on a user interface, the candidate behavior record that exceeds a predefined threshold as a predicted next action, where the predicted next action is identified and outputted within a real-time constraint after entry of the last token in the current behavior record by the user.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user’s device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

What is claimed is:

1. A computer-implemented method comprising:
obtaining, by one or more computers, session records from each of one or more users, wherein the session records specify information indicative of behaviors by the one or more users over a period of time;
identifying, by the one or more computers and across the session records, a set of behavior records indicative of at least a specified number of most frequent behaviors;
generating, by the one or more computers and for each behavior record in the set of behavior records, an embedding;
storing, by the one or more computers, the generated embeddings for the set of behavior records in a first database;
obtaining, by the one or more computers and from the user, a current behavior record;
matching, by the one or more computers, the current behavior record to a matching set of stored behavior records;
selecting, by the one or more computers, the stored embedding of the matching set of stored behavior records as an embedding of the current behavior record based on the matching and within a real-time constraint following entry of the current behavior record by the user; and
generating, by the one or more computers and based on the embedding of the matching set of stored behavior records, a predicted next action of the user after entry of a last token in the current behavior record by the user.

2. The method of claim 1, wherein session records comprise an identifier of the user and one or more behaviors by the user, wherein behaviors comprise one or more tokens received from the user and one or more actions taken by the user within the period of time.

3. The method of claim 2, wherein tokens comprise one or more query terms entered by the user.

4. The method of claim 1, wherein generating an embedding comprises creating a vector representation in a low dimensional space.

5. The method of claim 1, wherein matching the current behavior record to a matching set of stored behavior records comprising:
determining a measure of similarity between the current behavior record and each behavior record in the first database; and
identifying the matching set of behavior records based on the measure of similarity.

6. The method of claim 1, comprising:
generating candidate behavior records, each indicative of the predicted next action following the last token in the current behavior record by the user;
identifying, across the candidate behavior records, a set of candidate behavior records indicative of at least a specified number of most frequent candidate behaviors;
generating, for each candidate behavior record in the set of candidate behavior records, an embedding;
storing the generated embeddings for the set of candidate behavior records in a second database;
obtaining, from the user, a current candidate behavior record;
matching the current behavior record to a matching set of stored candidate behavior records; and
selecting the stored embedding of the matching set of stored candidate behavior records as an embedding of the current candidate behavior record based on the matching and within a real-time constraint following generating the candidate behavior record.

7. The method of claim 6, comprising:
generating a ranker model that predicts a likelihood of each candidate behavior record leading to one or more actions by the user;
obtaining the score, for each candidate behavior record, based on the ranker model and the embedding of the candidate behavior record; and
providing, for output on a user interface, the candidate behavior record that exceeds a predefined threshold as a predicted next action, wherein the predicted next action is identified and outputted within a real-time constraint after entry of the last token in the current behavior record by the user.

8. A system comprising:
one or more computers and one or more storage devices storing instructions that are operable, when executed by the one or more computers, to cause the one or more computers to perform operations comprising:
obtaining, by the one or more computers, session records from each of one or more users, wherein the session records specify information indicative of behaviors by the one or more users over a period of time;
identifying, by the one or more computers and across the session records, a set of behavior records indicative of at least a specified number of most frequent behaviors;
generating, by the one or more computers and for each behavior record in the set of behavior records, an embedding;
storing, by the one or more computers, the generated embeddings for the set of behavior records in a first database;
obtaining, by the one or more computers and from the user, a current behavior record;
matching, by the one or more computers, the current behavior record to a matching set of stored behavior records;
selecting, by the one or more computers, the stored embedding of the matching set of stored behavior records as an embedding of the current behavior record based on the matching and within a real-time constraint following entry of the current behavior record by the user; and
generating, by the one or more computers and based on the embedding of the matching set of stored behavior records, a predicted next action of the user after entry of a last token in the current behavior record by the user.

9. The system of claim 8, wherein session records comprise an identifier of the user and one or more behaviors by the user, wherein behaviors comprise one or more tokens received from the user and one or more actions taken by the user within the period of time.

10. The system of claim 9, wherein tokens comprise one or more query terms entered by the user.

11. The system of claim 8, wherein generating an embedding comprises creating a vector representation in a low dimensional space.

12. The system of claim 8, wherein matching the current behavior record to a matching set of stored behavior records comprising:
determining a measure of similarity between the current behavior record and each behavior record in the first database; and
identifying the matching set of behavior records based on the measure of similarity.

13. The system of claim 8, comprising:
generating candidate behavior records, each indicative of the predicted next action following the last token in the current behavior record by the user;
identifying, across the candidate behavior records, a set of candidate behavior records indicative of at least a specified number of most frequent candidate behaviors;
generating, for each candidate behavior record in the set of candidate behavior records, an embedding;
storing the generated embeddings for the set of candidate behavior records in a second database;
obtaining, from the user, a current candidate behavior record;
matching the current behavior record to a matching set of stored candidate behavior records; and
selecting the stored embedding of the matching set of stored candidate behavior records as an embedding of the current candidate behavior record based on the matching and within a real-time constraint following generating the candidate behavior record.

14. The system of claim 13, comprising:
generating a ranker model that predicts a likelihood of each candidate behavior record leading to one or more actions by the user;
obtaining the score, for each candidate behavior record, based on the ranker model and the embedding of the candidate behavior record; and
providing, for output on a user interface, the candidate behavior record that exceeds a predefined threshold as a predicted next action, wherein the predicted next action is identified and outputted within a real-time constraint after entry of the last token in the current behavior record by the user.

15. A non-transitory computer-readable medium storing instructions that when executed by one or more computers cause the one or more computers to perform operations comprising:
obtaining, by the one or more computers, session records from each of one or more users, wherein the session records specify information indicative of behaviors by the one or more users over a period of time;
identifying, by the one or more computers and across the session records, a set of behavior records indicative of at least a specified number of most frequent behaviors;
generating, by the one or more computers and for each behavior record in the set of behavior records, an embedding;
storing, by the one or more computers, the generated embeddings for the set of behavior records in a first database;
obtaining, by the one or more computers and from the user, a current behavior record;
matching, by the one or more computers, the current behavior record to a matching set of stored behavior records;
selecting, by the one or more computers, the stored embedding of the matching set of stored behavior records as an embedding of the current behavior record based on the matching and within a real-time constraint following entry of the current behavior record by the user; and
generating, by the one or more computers and based on the embedding of the matching set of stored behavior records, a predicted next action of the user after entry of a last token in the current behavior record by the user.

16. The non-transitory computer-readable medium of claim 15, wherein session records comprise an identifier of the user and one or more behaviors by the user, wherein behaviors comprise one or more tokens received from the user and one or more actions taken by the user within the period of time.

17. The non-transitory computer-readable medium of claim 16, wherein tokens comprise one or more query terms entered by the user.

18. The non-transitory computer-readable medium of claim 15, wherein matching the current behavior record to a matching set of stored behavior records comprising:
determining a measure of similarity between the current behavior record and each behavior record in the first database; and
identifying the matching set of behavior records based on the measure of similarity.

19. The non-transitory computer-readable medium of claim 15, comprising:
generating candidate behavior records, each indicative of the predicted next action following the last token in the current behavior record by the user;
identifying, across the candidate behavior records, a set of candidate behavior records indicative of at least a specified number of most frequent candidate behaviors;
generating, for each candidate behavior record in the set of candidate behavior records, an embedding;
storing the generated embeddings for the set of candidate behavior records in a second database;
obtaining, from the user, a current candidate behavior record;
matching the current behavior record to a matching set of stored candidate behavior records; and
selecting the stored embedding of the matching set of stored candidate behavior records as an embedding of the current candidate behavior record based on the matching and within a real-time constraint following generating the candidate behavior record.

20. The non-transitory computer-readable medium of claim 19, comprising:
generating a ranker model that predicts a likelihood of each candidate behavior record leading to one or more actions by the user;
obtaining the score, for each candidate behavior record, based on the ranker model and the embedding of the candidate behavior record; and
providing, for output on a user interface, the candidate behavior record that exceeds a predefined threshold as a predicted next action, wherein the predicted next action is identified and outputted within a real-time constraint after entry of the last token in the current behavior record by the user.
